(19) United States
(12) Patent Application Publication
(10) Pub. No.: US 2007/0273633 A1
(43) Pub. Date: Nov. 29, 2007

(54) DISPLAY DRIVING CIRCUIT AND DRIVING METHOD

(75) Inventors: Yoshiharu Hashimoto, Kanagawa (JP); Takayuki Shu, Kanagawa (JP); Masayuki Kumeta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 11/745,976

(22) Filed: May 8, 2007

(30) Foreign Application Priority Data
May 29, 2006 (JP) 2006-149017

(51) Int. Cl. G09G 3/36

(52) U.S. Cl. 345/98

(57) ABSTRACT

A driving circuit for a display apparatus includes a common line driver that supplies at least two different common voltages to a common line included in the display apparatus, a plurality of data line drivers that supply a data voltage to each of a plurality of data lines included in the display apparatus, and a switch section that has a larger operating voltage range than that of the data line drivers and temporarily short-circuits the common line and the data line.

### BACKGROUND OF THE INVENTION

1. Field of the Invention

The present invention relates to a driving circuit for a display apparatus and a driving method of the same.

2. Description of Related Art

A variety of performances are required for a driving device of display apparatus (liquid crystal displays). Particularly, it is important to implement low power consumption of display apparatus. Recently, as liquid crystal displays provide higher resolution and larger screen sizes, the number of column lines (data lines) and parasitic capacitance increase, resulting in higher power consumption of a driving device.

Common inversion driving is known as a driving system for a driving circuit for active matrix liquid crystal displays using a thin film transistor (TFT) as a switching element in each pixel (cf. Japanese Unexamined Patent Application Publication No. 2005-284271 (Related art 1)). The common inversion driving system inverts the polarity of a voltage which is applied to a common line at each predetermined time period. The common inversion driving system prevents the degradation of a liquid crystal material that is included in each pixel. However, the inversion of the polarity of a voltage applied to a pixel requires charge and discharge of parasitic capacitance (e.g. line capacitance and TFT capacitance) of a data line, thus increasing power consumption. The operation of inverting the voltage polarity may be performed for each frame or each scan line.

Japanese Unexamined Patent Application Publication No. 2002-244622 (Related art 2) discloses a technique of temporarily short-circuiting a common line and a data line which are included in a liquid crystal display before the above-described operation of inverting the voltage polarity to thereby reduce the power consumption of a driving circuit.

FIG. 18 schematically shows the configuration disclosed in Related art 2. As shown in FIG. 18, a switch 503 which is included in a data line driver 203 turns ON in response to a control signal SHT. At this time, a common line LCOM and a data line LDATA which are included in a liquid crystal display 600 are short-circuited. The voltage of the common line LCOM and the voltage of the data line LDATA are thereby equalized. This reduces the power of a driving circuit 500 which is required for inverting the polarity of the voltage to be applied to a pixel.

As shown in FIG. 18, the driving circuit 500 is connected with the liquid crystal display 600 through terminals pc, p1 and p2. The driving circuit 500 includes a common line driver 204 and the data line driver 203. According to the operation of the data line driver 203 or the common line driver 204, a desired voltage is supplied to the data line LDATA or the common line LCOM which are included in the liquid crystal display 600.

The range of an operating voltage of a common line driver and the range of an operating voltage of a data line driver may differ due to switching noise of a TFT included in a pixel. Further, the switch 503 shown in FIG. 18 is generally composed of a transfer switch or the like, and one end of the switch 503 is always connected with a common line regardless of ON or OFF of the switch 503. If the common line driver 204 operates at the voltage range of 4V to −1V and the data line driver 203 operates at the voltage range of 5V to 0V, when the common line driver 204 supplies −1V to a common line, the voltage of the common line can be clamped to about −0.5V due to a parasitic diode formed in the switch 503. This is because, if the data line driver 203 operates at the voltage range of 0V to 5V, the switch 503, which is composed of an analog switch or the like, also operates at the voltage range of 0V to 5V.

Although such a problem does not occur if the data line driver 203 is set to operate at the voltage range of 5V to −1V, the operating voltage of the data line driver 203 has an amplitude of 6V then, which increase power consumption.

As described above, it is difficult to temporarily short-circuit a common line and a data line without increasing power consumption of a data line driver when the ranges of operating voltages of the common line driver and the data line driver are different.

### SUMMARY

According to one aspect of the present invention, there is provided a driving circuit for a display apparatus including a common line driver to supply at least two different common voltages to a common line included in the display apparatus, a plurality of data line drivers to supply a data voltage to each of a plurality of data lines included in the display apparatus, and a switch section having a larger operating voltage range than that of the data line drivers, to temporarily short-circuit the common line and the data line.

According to another aspect of the present invention, there is provided a driving method of a driving circuit including a common line driver to supply at least two different common voltages to a common line included in a display apparatus, a plurality of data line drivers to supply a data voltage to each of a plurality of data lines included in the display apparatus, and a switch section having a larger operating voltage range than that of the data line drivers to temporarily short-circuit the common line and the data line. The method includes supplying a common voltage from the common line driver to the common line when the switch section is OFF.

According to the aspects of the present invention, the operating voltage range of the switch is set wider than the operating voltage range of the data line driver, thereby preventing an increase in power consumption of the data line driver even if different operating voltage ranges are set to the common line driver and the data line driver.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic view to describe a driving circuit according to a first embodiment of the present invention;

FIG. 2 is a schematic view to describe voltages generated by power supplies;

FIG. 3 is a schematic view to describe a withstand voltage and an operating voltage range of a switch;

FIG. 4 is a schematic view to describe the cross-sectional configuration of a switch 5;

FIG. 5 is a schematic view to describe the cross-sectional configuration of a switch 23;

FIG. 6 is a schematic view to describe the cross-sectional configuration of a switch 11;

FIG. 7 is a schematic view to describe the cross-sectional configuration of a switch composed of a low-withstand voltage element;

FIG. 8 is a schematic view to describe the cross-sectional configuration of a switch composed of an intermediate-withstand voltage element;

FIG. 9 is a schematic view to describe the cross-sectional configuration of a switch composed of a high-withstand voltage element;

FIG. 10 is a timing chart to describe the operation of the driving circuit according to the first embodiment of the present invention;

FIG. 11 is a schematic view to describe the driving circuit according to a second embodiment of the present invention;

FIG. 12 is a timing chart to describe the operation of the driving circuit according to the second embodiment of the present invention;

FIG. 13 is a schematic view to describe the driving circuit according to a third embodiment of the present invention;

FIG. 14 is a schematic view to describe the driving circuit according to a fourth embodiment of the present invention;

FIG. 15 is a timing chart to describe the operation of the driving circuit according to the fourth embodiment of the present invention;

FIG. 16 is a schematic view to describe the driving circuit according to a fifth embodiment of the present invention;

FIG. 17 is a schematic view to describe a withstand voltage and an operating voltage range of a switch; and

FIG. 18 is a schematic view to describe a driving circuit according to a related art.

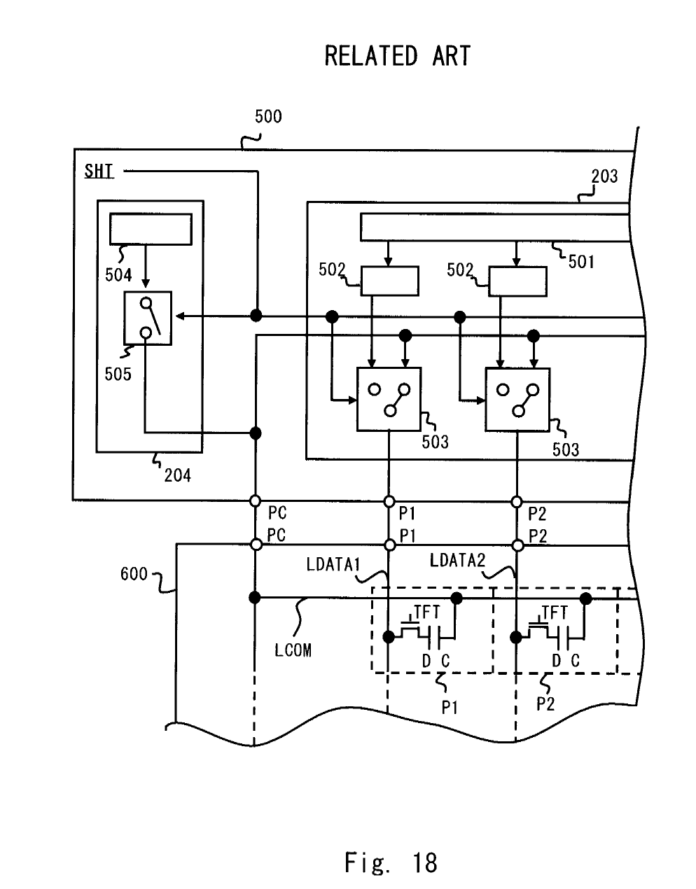

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

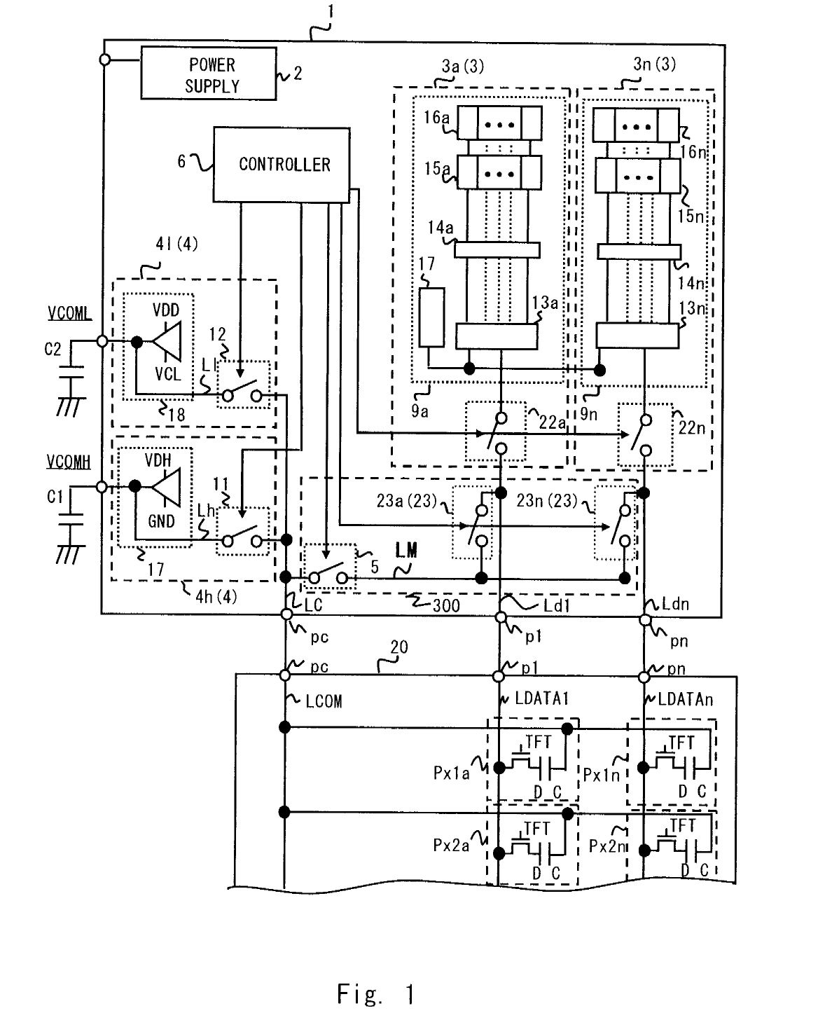

FIG. 1 shows a driving circuit according to a first embodiment of the present invention. As shown in FIG. 1, the driving circuit 1 is connected with a liquid crystal display (display apparatus) 20 through terminals pc, p1 and pn. Although not shown, there are a plurality of terminals between the terminals p1 and pn, and circuit elements which are connected to the terminal p1 (e.g. a switch 23a, a data line driver 3a and so on as described later) are connected in the same manner to each terminal. This is the same for the liquid crystal display side.

The liquid crystal display 20 is a device to display images. The liquid crystal display 20 includes pixels Px1a, Px1n, Px2a and Px2n at the intersections of a capacitor line that is connected with a common line LCOM along the row direction with a data line (column line) LDATA along the column direction in FIG. 1.

The pixels Px1a, Px1n, Px2a and Px2n respectively include a thin film transistor (TFT), a pixel electrode D, and a common electrode C (COM). The pixel electrode D and the common electrode C (COM) form a pair of electrodes. The TFT is an N-channel transistor. The gate of the TFT is connected with a scan line, which is not shown. The TFT turns ON or OFF in accordance with H (15V) or L (−15V) of a scan signal VG that is supplied through the scan line. The scan line also lies along the row direction in FIG. 1 just like the capacitor line that is connected with the common line LCOM. One end of the TFT is connected with the data line LDATA, and the other end is connected with the pixel electrode D. The common electrode C is connected with a common line LCOM. The pixel electrode D and the common electrode C are normally arranged face to face each other. The configuration, however, is not limited thereto.

The driving circuit 1 includes a power supply 2, a data line driver 3, a common line driver 4, a switch 23 (first switch), a switch 5 (second switch), and a controller 6. The power supply 2 generates a voltage to be supplied to circuit elements. The data line driver 3 supplies a desired data voltage to the data line LDATA. The common line driver 4 supplies a desired common voltage to the common line LCOM. The switch 23 is used to short-circuit the common line LCOM and the data line LDATA. The switch 5 functions in the same manner as the switch 23. The controller 6 controls each switch in the driving circuit 1.

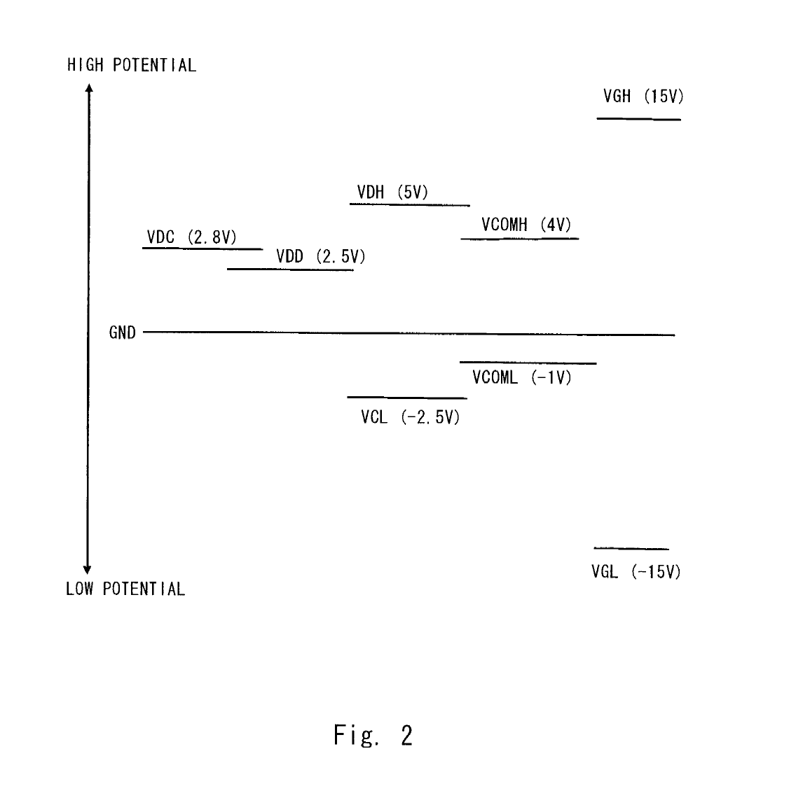

Referring to FIG. 2, the power supply 2 generates VDD (2.5V), VDH (5V), VCL (−2.5V), VCOMH (4V), VCOML (−1V), VGH (15V) and VGL (−15V) based on a power supply voltage VDC (2.8V) that is supplied from the outside of the driving circuit 1. GND potential (0V) is also supplied from the outside of the driving circuit 1. The power supply 2 first generates VDD and then generates VDH, which is 2 times the level of VDD, and VCL, which is −1 time the level of VDD using a charge pump DC-DC converter that is composed of a capacitor and a switch. The power supply 2 generates VGH and VGL if the driving circuit 1 includes a circuit to drive a scan line in a liquid crystal panel.

In this configuration, VCOMH corresponds to an upper limit of a common voltage that is supplied to a common line from the common line driver. VCOML corresponds to a lower limit of a common voltage that is supplied to a common line from the common line driver. VDH corresponds to an upper limit of a data voltage that is supplied to a data line from the data line driver. GND corresponds to a lower limit of a data voltage that is supplied to a data line from the data line driver.

The data line driver 3, the common line driver 4 and a switch section 300 are described hereinafter.

### [Data Line Driver]

The data line driver 3 supplies a data voltage (a predetermined voltage to be supplied to each pixel) to the pixel electrode D of the pixels Px1a to Px1n, Px2a to Px2n and so on through a line Ld (lines Ld1 to Ldn) and a data line LDATA (data lines LDATA1 to LDATAn).

The driving circuit 1 includes a data line driver 3a and a data line driver 3n. The data line drive 3 (3a, 3n) includes a data voltage generator 9 (9a, 9n) and a switch 22 (22a, 22n). The data voltage generator 9 includes a first data latch section 16 (16a, 16n), a second data latch section 15 (15a, 15n), a level shift section 14 (14a, 14n), and a buffer 13 (13a, 13n) to perform D-A conversion. The first data latch section 16 and the second data latch section 15 receive voltages of VDD (2.5V) to GND (0V). A digital signal which is stored in the second data latch section 15 is converted to have a higher voltage by the level shift section 14 and transmitted to the buffer 13. The buffer 13 converts the transmitted digital signal into an analog signal using a voltage that is generated in a gradation voltage generator 17. The buffer 13 operates at the voltage range of VDH (5V) to GND (0V).

The switch 22 (fifth switch) determines the output state of a data line driver based on a control signal from the controller 6. The switch 22a turns ON and OFF when appropriate based on a control signal from the controller 6. A data voltage is output from the data line driver to the data line LDATA when the switch 22a is ON. One end of the switch 22a is connected with the buffer 13a and the other end is connected with the line Ld1.

The data voltage which is output from the data line driver 3 to the data line LDATA is set to the range of VDH (5V) to GND (0V). Accordingly, the range of the operating voltage of the switch 22 is set from VDH (5V) to GND (0V). The switch 22 is composed of an element having a 5V withstand voltage (The switch 22 is a 5V withstand voltage element).

Although it is described as the 5V withstand voltage element, a voltage at which breakdown actually occurs is about 7V, which is about 40% higher. It is called the 5V withstand voltage element for convenience because the amplitude (higher level lower level) of a voltage used is 5V.

The range of the operating voltage of the data line driver is regulated by the amplitude of the data voltage which is supplied from the data line driver to the data line LDATA. The operating voltage of the data line driver thus ranges from VDH (5V) to GND (0V). VDH (5V) is a higher voltage of the data line driver. GND (0V) is a lower voltage of the data line driver.

### [Common Line Driver]

The common line driver 4 outputs a common voltage (VCOML, VCOMH) to the common electrode C which is included in the pixels Px1a to Px1n, Px2a to Px2n. The common line driver 4 includes a VCOMH generating driver 4h and a VCOML generating driver 41. The VCOMH generating driver 4h outputs a common voltage VCOMH (4V) to a common line. The VCOML generating driver 41 outputs a common voltage VCOML (−1V) to a common line.

The common line driver 4 is connected with a line LC. The line LC is connected with the common line LCOM through the terminal pc. The line LC is also connected with one end of the switch 5, which is described later.

A voltage difference between the common voltages VCOMH (4V) and VCOML (−1V) is 5V. This is the range that the above-described data voltage range VDH (5V) to GND (0V) is shifted by about −1V to the negative side, or, that an offset of about −1V is added to the above range in the negative side. Such a setting prevents the reduction of a voltage of the pixel electrode D due to switching noise in a TFT included in each pixel of the liquid crystal display 20.

The switching noise of a TFT means that, when a voltage, which is applied to the gate of a TFT included in each pixel from a scan line (not shown) of the liquid crystal display 20, is changed from VGH (15V) to VGL (−15V), the charge of the pixel electrode D is drawn by VGL and divided by the parasitic capacitance of the TFT, thereby reducing the potential of the pixel electrode D.

The VCOMH generating driver 4h includes a switch 11 (third switch) and a high-voltage generator 17. The high-voltage generator 17 includes an operational amplifier and generates VCOMH according to the operation of the operational amplifier. The operating voltage of the high-voltage generator 17 ranges from VDH (5V) to GND (0V). One end of the capacitor C1 is connected with the output end of the operational amplifier, and the other end is grounded.

The switch 11 determines the output state of the VCOMH generating driver 4h based on a control signal from the controller 6. The switch 11 turns ON or OFF when appropriate based on a control signal from the controller 6. The common line LCOM and the line LC are set to VCONH when the switch 11 is ON.

One end of the switch 11 is connected with the line LC, and the other end is connected with the high-voltage generator 17 (between the output end of the operational amplifier and the capacitor C1). A voltage of VCOMH (4V) to VCOML (−1V) is supplied to one end of the switch 11. The operating voltage of the switch 11 ranges from VCOMH (4V) to VCOML (−1V). The switch 11 is composed of a 5V withstand voltage element.

The VCOML generating driver 41 includes a switch 12 (third switch) and a low-voltage generator 18. The low-voltage generator 18 includes an operational amplifier and generates VCOML according to the operation of the operational amplifier. The operating voltage of the low-voltage generator 18 ranges from VDD (2.5V) to VCL (−2.5V). One end of the capacitor C2 is connected with the output end of the operational amplifier, and the other end is grounded.

The switch 12 determines the output state of the VCOML generating driver 41 based on a control signal from the controller 6. The switch 12 turns ON or OFF based on a control signal from the controller 6. The common line LCOM and the line LC are set to VCOML when the switch 12 is ON.

One end of the switch 12 is connected with the line LC, and the other end is connected with the low-voltage generator 18 (between the output end of the operational amplifier and the capacitor C2). A voltage of VCOMH (4V) to VCOML (−1V) is supplied to one end of the switch 12. The operating voltage of the switch 12 ranges from VCOMH (4V) to VCOML (−1V). The switch 12 is composed of a 5V withstand voltage element.

The range of the operating voltage of the common line driver is regulated by the amplitude of the common voltage which is supplied from the common line driver to the common line LCOM. The operating voltage of the common line driver thus ranges from VCOMH (4V) to VCOML (−1V). VCOMH (4V) is a higher voltage of the common line driver. VCOML (−1V) is a lower voltage of the common line driver.

### [Switch Section 300]

The driving circuit 1 of this embodiment includes the switch section 300. The switch section 300 includes the switch 23 (first switch) and the switch 5 (second switch). If the controller 6 sets the switch 23 and the switch 5 to be ON-state at the same time, the common line and the data line are short-circuited. The operating voltage range of the switch section 300 is set larger than the operating voltage range of the data line driver 3 as described later.

The operating voltage of the switch section 300 in this embodiment ranges from the lower one of the lower limits (lower voltages) of the operating voltage ranges of the switch 23 and the switch 5 to the higher one of the upper limits (higher voltages) of the operating voltage ranges of the switch 23 and the switch 5.

The switch 23 turns ON or OFF based on a control signal from the controller 6.

The switch 23 is placed for each of a plurality of data lines LDATA. The switch 23 is placed in parallel with the data line driver with respect to the data line LDATA. One end of the switch 23a is connected with the data line LDATA through the line Ld1. The other end is electrically connected with the common line LCOM through a mid-line LM and the switch 5, which is described later. The mid-line LM connects one ends of the switch 23a, 23n with one end of the switch 5.

The switch 23 is composed of a transfer switch using a pair of a P-type MOS (Metal Oxide Silicon) transistor and an N-type MOS transistor. The switch 23 receives a voltage of VDH (5V) to GND (0V). The operating voltage of the switch 23 ranges from VDH (5V) to GND (0V). The switch 23 is composed of an element having a 5V withstand voltage (The switch 23 is a 5V withstand voltage element).

One end of the switch 5 is connected with the switch 23 and the other end is connected with the common line LCOM. The switch 5 is composed of a transfer switch using a pair of a P-type MOS transistor and an N-type MOS transistor. The switch 5 is composed of an element having a higher withstand voltage than the switch 23, the switch 11 and the switch 12. The switch 5 receives a voltage of VDH (5V) to VCOML (−1V). The operating voltage of the switch 5 ranges from VDH (5V) to VCOML (−1V). The switch 5 is composed of an element having a 6V withstand voltage (The switch 5 is a 6V withstand voltage element).

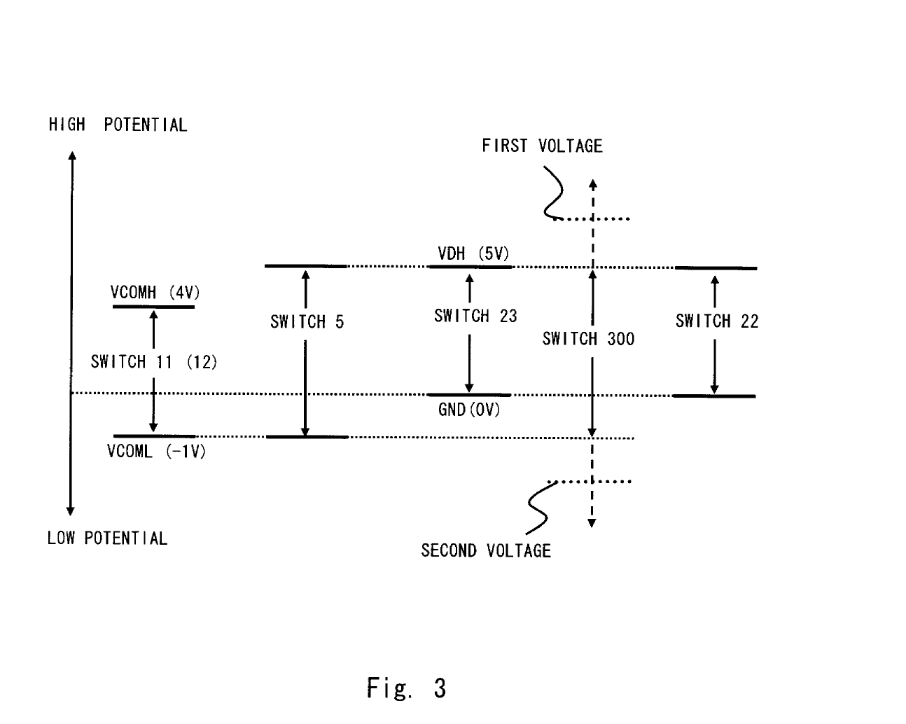

The withstand voltage and the operating voltage range of the switch section 300 (the switch 5 and the switch 23) are described hereinafter with reference to FIG. 3. The operating voltage range and the withstand voltage of the switch 11 (the switch 12) and the switch 22 are also described herein after.

As shown in FIG. 3, the switch 5 (second switch), which is included in the switch section 300, is composed of an element having a 6V withstand voltage (The switch 5 is a 6V withstand voltage element). The element withstands a voltage difference between VDH (5V) and VCOML (−1V). In the 6V withstand voltage element, a voltage at which breakdown actually occurs is about 10V to 12V. It is called the 6V withstand voltage element for convenience because the amplitude (higher level lower level) of a voltage used is 6V, just like the 5V withstand voltage element described earlier.

VDH is an upper limit (higher voltage) of a data voltage which is supplied from the data line driver to the data line. VCOML is a lower limit (lower voltage) of a common voltage which is supplied from the common line driver to the common line. The range of the operating voltage of the switch 5 is thus set to the voltage range which is regulated by a voltage (first voltage) of equal to or higher than a higher voltage VDH (5V) of the data voltage and a voltage (second voltage) of equal to or lower than a lower voltage VCOML (−1V) of the common voltage. The operating voltage of the data line driver 3 ranges from VDH (5V) to GND (0V). Thus, the operating voltage range of the switch 5 is larger than the operating voltage range of the data line driver.

The switch 23 is composed of an element having a 5V withstand voltage (The switch 23 is a 5V withstand voltage element). The switch 11 (third switch) is composed of an element having a 5V withstand voltage (The switch 11 is a 5V withstand voltage element). Both the switches 23 and 11 are thus composed of an element having a lower withstand voltage than that of the switch 5. The operating voltage range of the switch 23 is the same as the operating voltage range of the data line driver 3. The operating voltage of the switch 23 is thus equal to or lower than the higher voltage VDH (5V) and equal to or higher than the lower voltage GND (0V) of the operating voltage range of the data line driver. The operating voltage range of the switch 23 is included in the range which is equal to or higher than the lower voltage VCOML (−1V) of the common voltage which is supplied from the common line driver to the common line.

The range of the operating voltage of the switch section 300 is regulated by the range of the operating voltage of the switch 5 in this embodiment.

The switch 22 (22a, 22n) which determines the output state of the data line driver 3 is composed of an element having the same withstand voltage as the switch 23 (23a, 23n). Further, the switch 22 has the same operating voltage range as the switch 23.

In this embodiment, the withstand voltage of an element which forms the switch 5 is set higher than the withstand voltage of an element which forms the switch 23. Addition of the switch composed of a high withstand voltage element causes an increase in chip area of the driving circuit 1. However, the degree of an increase in chip area of the driving circuit 1 is smaller compared with the degree of an increase when using a high withstand voltage element for the switch 23. This is because the switch 23 is placed for each of the plurality of data lines LDATA included in the liquid crystal display 20. The switch 5, on the other hand, is placed in common for the plurality of data lines LDATA and does not depend on the number of data lines. Therefore, by setting the withstand voltage of the element which forms the switch 5 to be higher than the withstand voltage of the element which forms the switch 23, it is possible to set different ranges of operating voltages to the common line driver 4 and the data line driver 3 without increasing the chip area of the driving circuit 1. In cases where an increase in chip area does not cause any problem, the withstand voltage of the element which forms the switch 23 may be set high.

If each switch is composed of a MOS transistor, the withstand voltage of the element is determined by the length of the gate electrode or the thickness of the gate oxide film. As the gate electrode is longer, the withstand voltage of the MOS transistor is higher, which instead increases the chip area required for the formation of the MOS transistor.

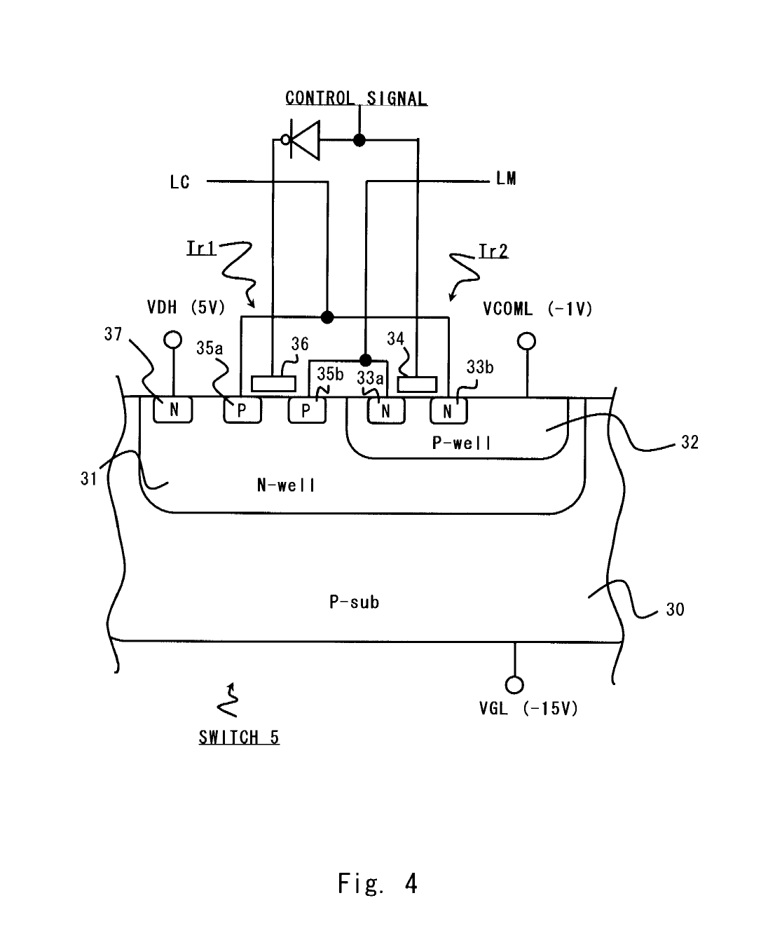

FIG. 4 is a schematic cross-sectional view of the switch 5 as a transfer switch. As shown in FIG. 4, a deep well 31 of a second conductivity type (N type) is formed in a semiconductor substrate 30 of a first conductivity type (P type) in the switch 5. A P-type well 32 is formed in the deep well 31. VDH (5V) is supplied to the deep well 31 through an N-type contact area 37. VGL (−15V) is supplied to the substrate 30.

A P-type MOS transistor Tr1 is formed in the deep well 31. The transistor Tr1 includes P-type diffusion areas 35a and 35b and a gate electrode 36. An N-type MOS transistor Tr2 is formed in the well 32. The transistor Tr2 includes N-type diffusion areas 33a and 33b and a gate electrode 34. A gate oxide layer is not illustrated in FIG. 4.

The diffusion area 35a of the transistor Tr1 and the diffusion area 33b of the transistor Tr2 are connected with the line LC. The diffusion area 35b of the transistor Tr1 and the diffusion area 33a of the transistor Tr2 are connected with the line LM.

The switch 5 turns ON based on a control signal (ON-state voltage 5V) from the controller 6, so that the line LC and the line LM are electrically connected with each other. The switch 5 turns OFF based on a control signal (OFF-state voltage 1V) from the controller 6, so that the line LC and the line LM are electrically disconnected.

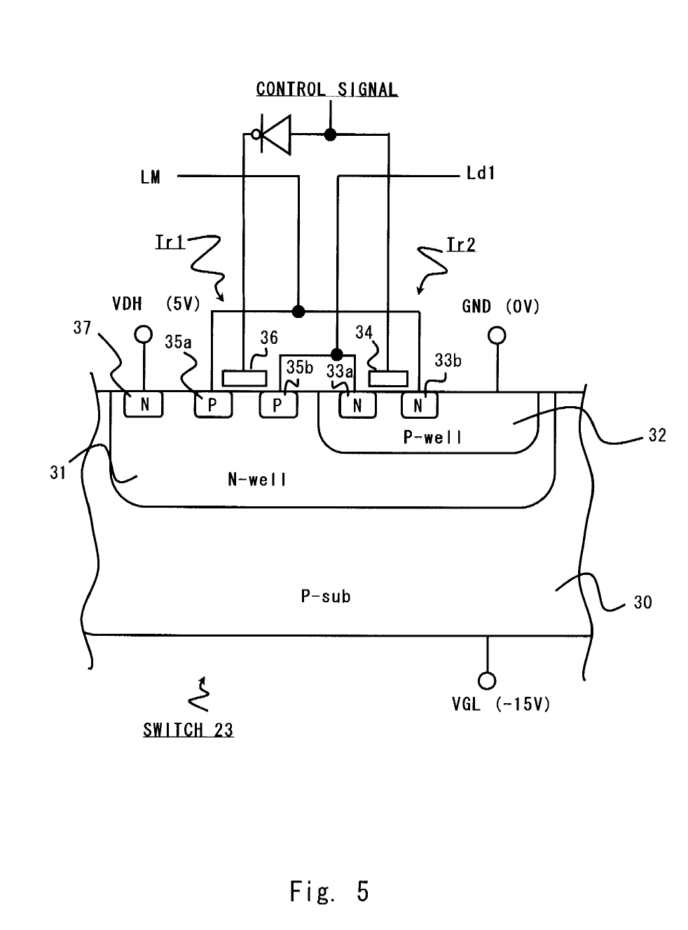

FIG. 5 is a schematic cross-sectional view of the switch 23 as a transfer switch. The switch 23 is different from the switch 5 in the operating voltage range. The well 32 of the switch 23 is set to GND (0V).

The switch 23 turns ON based on a control signal (ON-state voltage 5V) from the controller 6, so that the line Ld and the line LM are electrically connected with each other. The switch 23 turns OFF based on a control signal (OFF-state voltage 0V) from the controller 6, so that the line Ld and the line LM are electrically disconnected.

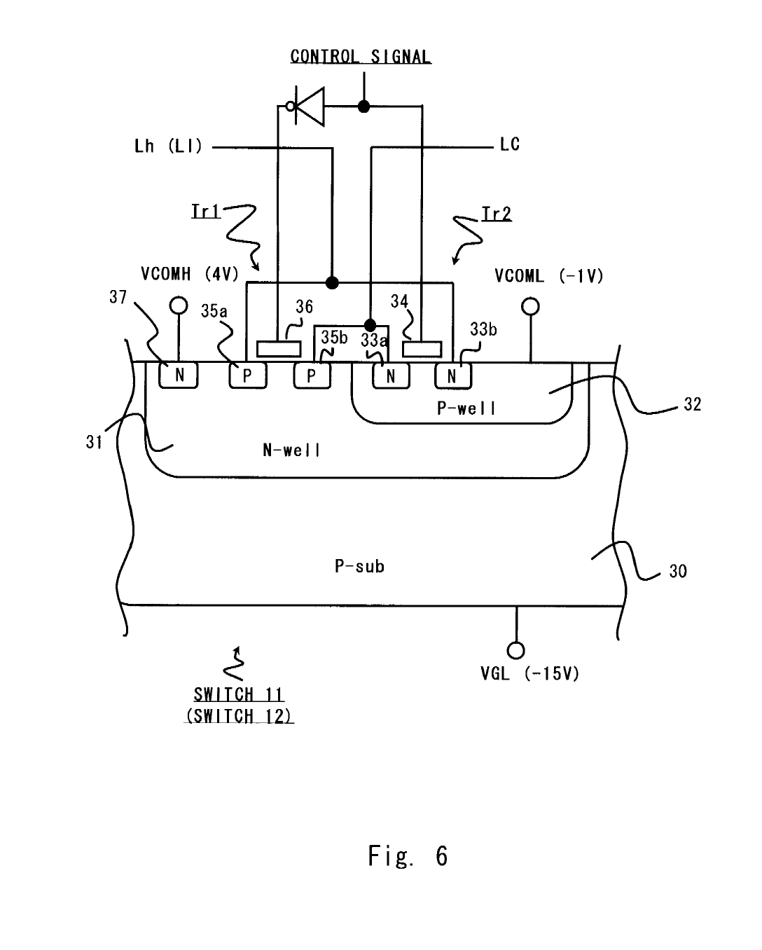

FIG. 6 is a schematic cross-sectional view of the switch 11 (switch 12) as a transfer switch. The switch 11 (12) is different from the switch 5 in the operating voltage range. The deep well 31 of the switch 11 (12) is set to VCOMH (4V). The well 32 of the switch 11 (12) is set to VCOML (−1V).

The switch 11 (switch 12) is not necessarily configured as a transfer switch, and a switch may be composed of a single MOS transistor. In such a case, the switch 11 is composed of a P-channel MOS transistor, and the switch 12 is composed of an N-channel transistor. One of the switches 11 and 12 is OFF when the other one is ON based on a control signal from the controller 6.

The switch 11 (switch 12) turns ON based on a control signal (ON-state voltage 4V) from the controller 6, so that the line Lh (line L1) and the line LC are electrically connected with each other. The switch 11 (switch 12) turns OFF based on a control signal (OEF-state voltage −1V) from the controller 6, so that the line Lh (line L1) and the line LC are electrically disconnected.

The withstand voltage of the circuit elements included in the driving circuit 1 is described hereinafter. A transistor having a 5V operating voltage range is called an intermediate withstand voltage element. A transistor having an operating voltage range above 5V is called a high withstand voltage element. A transistor having an operating voltage range below 5V is called a low withstand voltage element.

The switch 5 is composed of a high withstand voltage element. The switch 23, the switch 22, the switch 11 and the switch 12 are each composed of an intermediate withstand voltage element. The high-voltage generator 17 and the low-voltage generator 18 included in the common line driver 4 are composed of an intermediate withstand voltage element. The buffer 13 and the level shift section 14 included in the data line driver 3 are composed of an intermediate withstand voltage element. The data latch sections 15 and 16 are composed of a low withstand voltage element. Such a configuration enables the suitable operation of the driving circuit 1 and the suppression of power consumption in the driving circuit 1 at the same time.

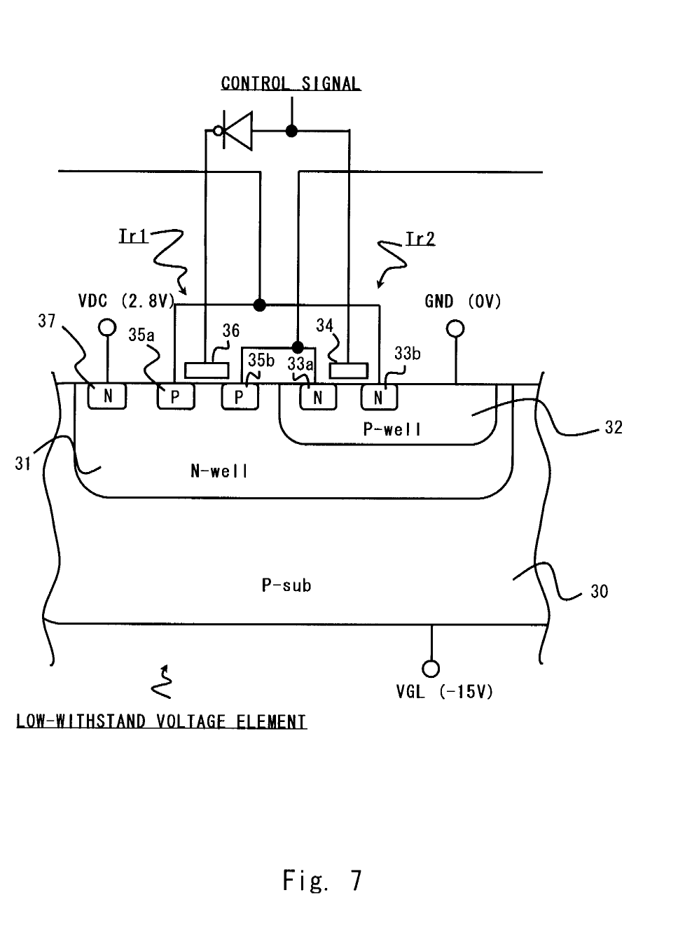

FIGS. 7 to 9 show the configurations of switches which are included in circuit elements other than the switches 5, 11, 12 and 23 in the driving circuit 1.

FIG. 7 shows a switch that is composed of a low withstand voltage element. This switch is different from the switch 5 in the range of its operating voltage. In this switch, the deep well 31 is set to VDC (2.8V). The well 32 is set to GND (0V).

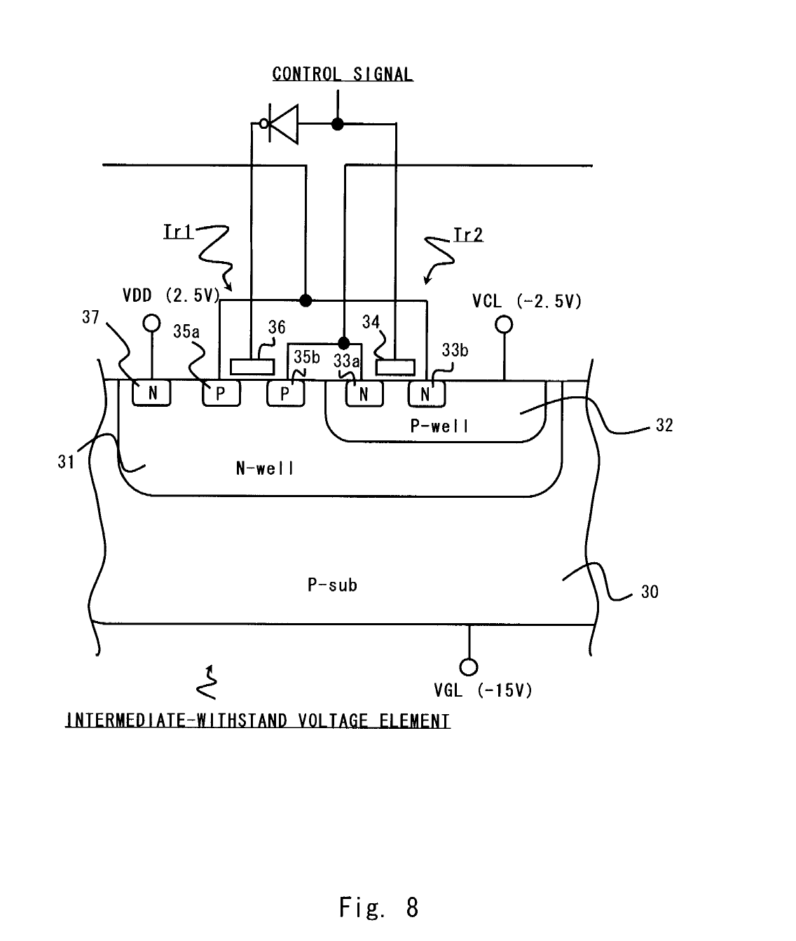

FIG. 8 shows a switch that is composed of an intermediate withstand voltage element. This switch is different from the switch 5 in the range of its operating voltage. In this switch, the deep well 31 is set to VDD (2.5V). The well 32 is set to VCL (−2.5V).

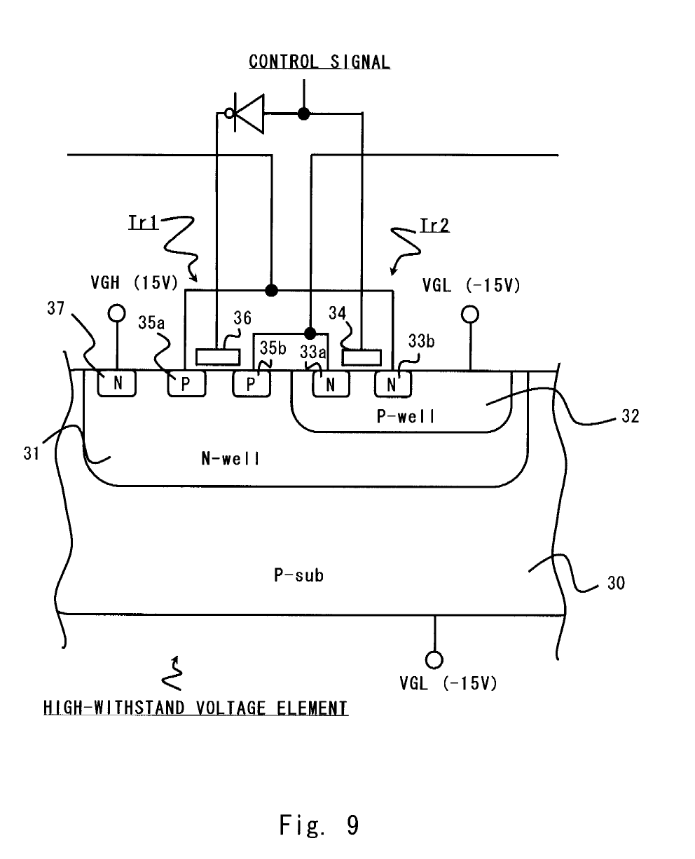

FIG. 9 shows a switch that is composed of a high withstand voltage element. This switch is different from the switch 5 in the range of its operating voltage. In this switch, the deep well 31 is set to VGH (15V). The well 32 is set to VGL (−15V).

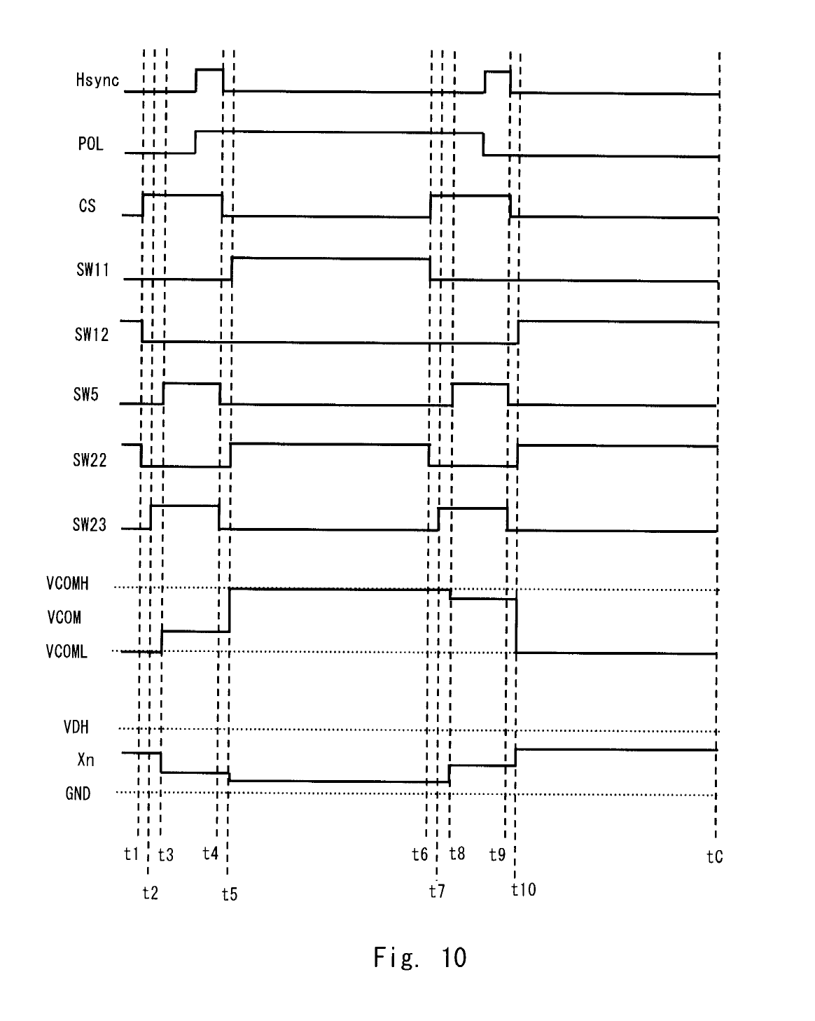

The operation of the driving circuit 1 is described hereinafter with reference to the timing chart of FIG. 10. In FIG. 10, Hsync indicates a horizontal synchronizing signal, which is a timing signal to be used when scanning each row of the liquid crystal display 20. POL indicates the polarity of a voltage which is applied to a pixel forming the liquid crystal display 20. CS indicates a timing signal to equalize the voltages of the common line and the data line. SW11, SW12, SW5, SW22 and SW23 indicate the states of the switches 11, 12, 5, 22 and 23, respectively. Each switch turns ON in response to a H level control signal and turns OFF in response to a L level control signal. VCOM indicates a voltage of a common line LCOM (common electrode D). Xn indicates a voltage of a data line.

In the following description, the liquid crystal display 20 is normally white, which displays white when no voltage is applied to a pixel, unless otherwise stated. VCOM is set to VCOML when POL is L level, and VCOM is set to VCOMH when POL is H level. If Xn indicates a voltage to display black, Xn is set to 4V when POL is L level, and Xn is set to 1V when POL is H level. If Xn indicates a voltage to display white, Xn is set to DV when POL is L level, and Xn is set to 5V when POL is H level. The value of Xn shown in FIG. 2 is merely an example, and it may be an arbitrary level within a given range. In FIG. 10, the time proceeds to t1 to tC.

At t1, CS becomes High (H). At this time, SW12 and SW22 turn OFF. Thus, an equalizing period to equalize a common line LCOM and a data line LDATA starts upon completion of a driving period of the liquid crystal panel 20. Then, at t2, SW23 turns ON. At t3, SW5 turns ON. The voltage of VCOM and the voltage of Xn are equalized when SW23 and SW5 are ON at the same time. During the equalizing period, the voltage VCOML (−1V) of VCOM and the voltage (4V) of Xn are equalized to 1.5V.

At t4, CS becomes Low (L). At this time, SW5 and SW23 turn OFF. At t5, SW11 and SW22 turn ON, at which time another driving period of the liquid crystal panel 20 starts.

At this time, VCOM is set to VCOMH (4V) according to POL. By the operation during the equalizing period described above, the voltage of VCOM is set higher, from VCOML (−1V) to 1.5V. Thus, the operation in the equalizing period allows reduction of power required for the driving circuit 1 to set the voltage of VCOM to VCOMH. Xn is set to a data voltage corresponding to a voltage to be applied to a pixel.

In this embodiment, SW5 is OFF when SW11 is ON. This eliminates a failure to apply a desired voltage to the common line LCOM.

Another equalizing period starts upon completion of the driving period which started after the completion of the above-described equalizing period. The timings t6, t7, t8, t9 and t10 correspond to t1, t2, t3, t4 and t5, respectively. A redundant description is not provided herein.

In the equalizing period, VCOM becomes lower, from VCOMH (4V) to 2.5V. On the other hand, Xn becomes higher, from 1V to 2.5V.

Further, SW5 is OFF when SW12 is ON. This eliminates a failure to apply a desired voltage to the common line LCOM.

### Second Embodiment

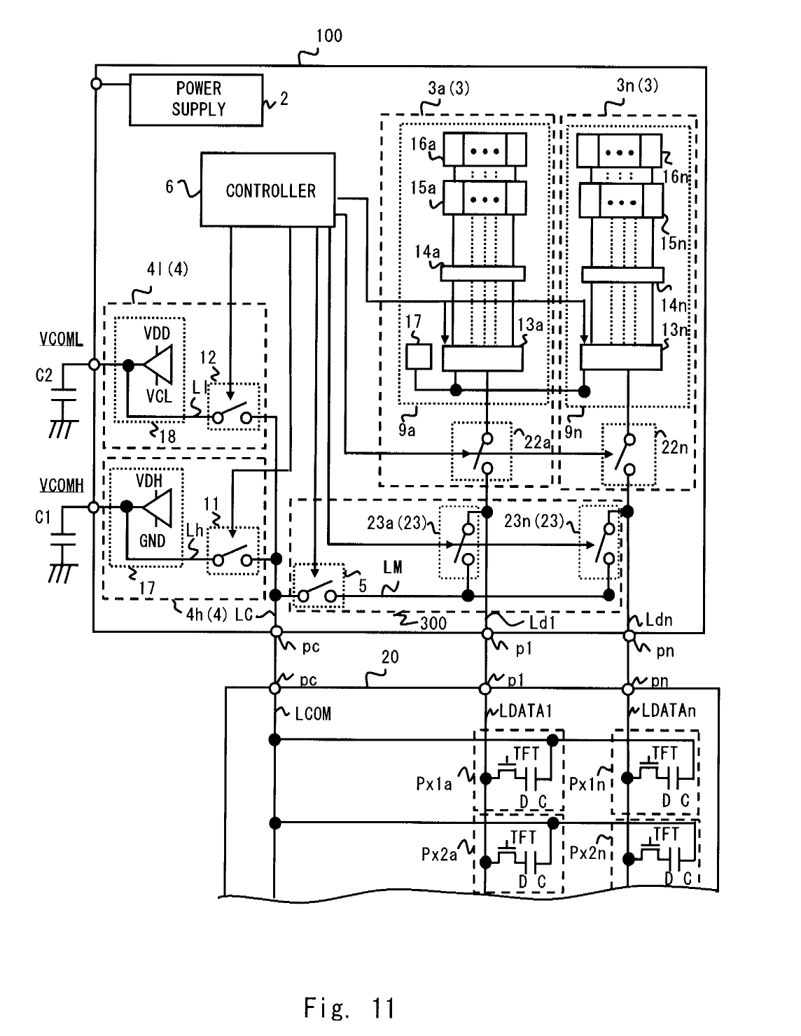

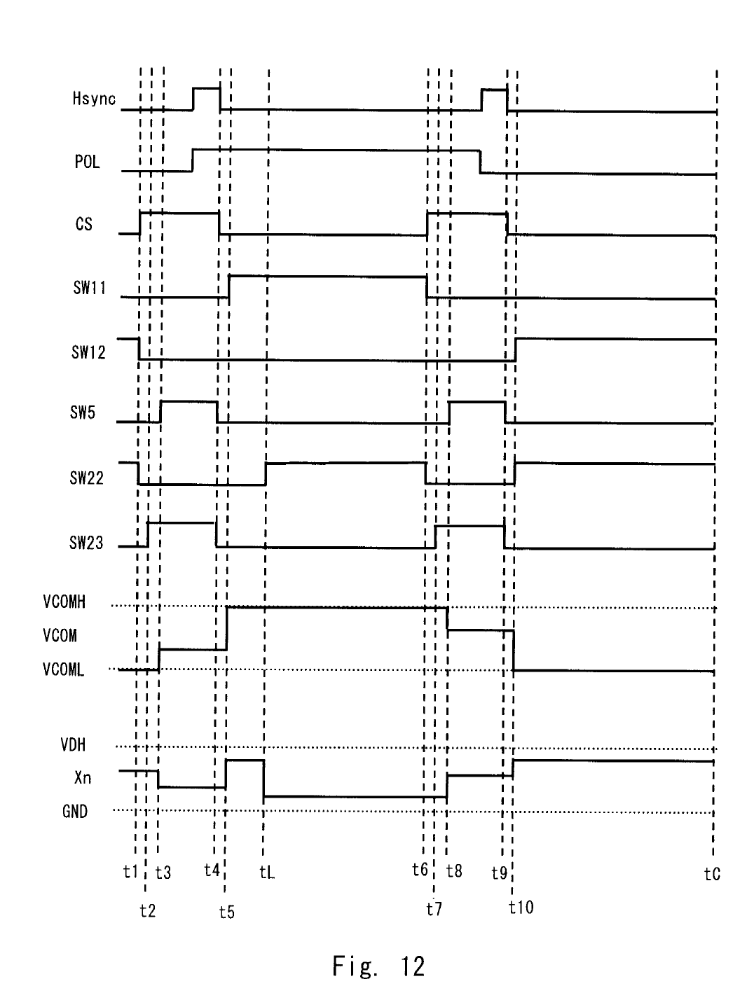

A second embodiment of the present invention is described hereinafter with reference to FIGS. 11 and 12. A redundant description is not provided herein.

The second embodiment is different from the first embodiment in that the controller 6 controls the buffer 13 (an operational amplifier included therein) to turn OFF to thereby reduce the power consumption required for the operation of the buffer 13 (an operational amplifier included therein).

The operation of a driving circuit 100 in this embodiment is described hereinafter with reference to the timing chart of FIG. 12. During the time period from t4 to tL, SW22 and SW23 are OFF, and the data line LDATA is in the high impedance state. Then, at t5, SW11 turns ON. VCOM thereby becomes higher to VCOMH. When the level of VCOM increases to VCOMH (4H), the level of Xn also increases to 4V because the data line is in the high impedance state. At tL, SW22 turns ON and Xn is set to a desired voltage. The value of Xn is set by discharging the charge of the data line to the GND line or the like. The power consumption of the driving circuit 100 can be therefore reduced. Further, the controller 6 sets a buffer 13a (an operational amplifier included therein) to be in the OFF state until the timing tL at which SW22 turns ON, thereby reducing the power consumption required for the operation of the buffer 13a.

On the other hand, when VCOM is set to VCOML, the above-described operation of setting the data line LDATA into the high impedance state so that the voltage of the data line LDATA follows a change in the voltage of the common line LCOM is not performed. This is because power for increasing the voltage of the data line LDATA is required. Thus, when the level of VCOM decreases to VCOML, SW22 is ON to thereby reduce the power consumption of the driving circuit 100.

### Third Embodiment

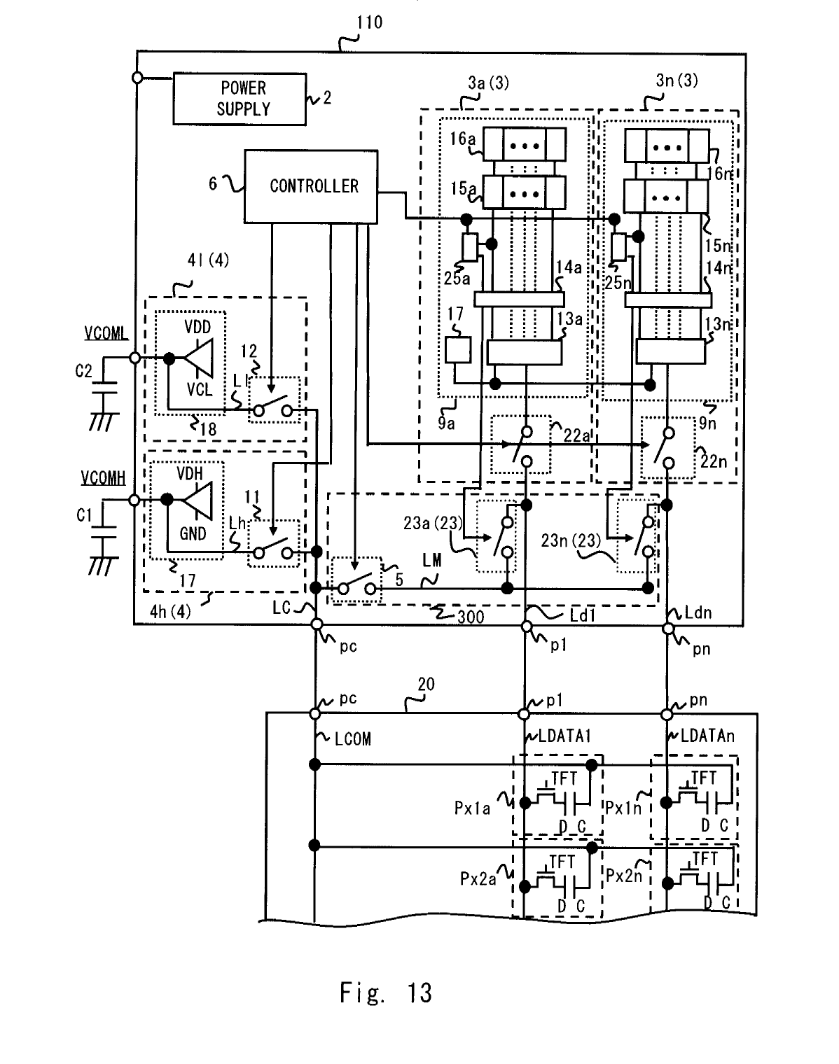

A third embodiment of the present invention is described hereinafter with reference to FIG. 13. A redundant description is not provided herein.

The third embodiment is different from the first embodiment in that the data line driver 3 (3a, 3n) includes a data determination circuit 25 (25a, 25n) as shown in FIG. 13. The data determination circuit 25 is connected with the controller 6 and also connected with a line between the data latch section 15 and the level shift section 14. The signal that is generated in the data determination circuit 25 (25a, 25n) is supplied to the switch 23 (23a, 23n) through the level shift section 14 (14a, 14n).

If a voltage Vx corresponds to white display in one driving period and it also corresponds to white display in the next driving period, the equalization of the data line LDATA and the common line LCOM results in an increase in power consumption of a driving circuit 110. If VCOM is at the level of VCOMH (4V) and Vx is set to a voltage corresponding to white display (e.g. 5V), the voltage (5V) of Vx is higher than VCOMH (4V). In such a case, if the common line LCOM and the data line LDATA are equalized, the voltage of VCOM becomes higher than VCOMH (4V). As a result, the power consumption of the driving circuit 110 to set the voltage of VCOM to VCOML (−1V) increases. Therefore, the data determination circuit 25a detects Vx based on a bit which is included in display data supplied from the data latch section 15 to the level shift section 14, and control the switch 23 according to the bit data, POL and CS so as not to perform the equalization of the common line LCOM and the data line LDATA when Vx is set to a voltage corresponding to white display (when a data voltage applied to the data line LDATA is higher than a common voltage applied to the common line) in successive driving periods. The bit data which is detected by the data determination circuit is preferably bit data (digial signal) containing a most significant bit (MSB).

The above-description is the same when the liquid crystal display 20 is normally black, which displays black when no voltage is applied to a pixel. If a TFT is a P-channel type, the conditions become opposite to those described above. Specifically, VCOM is at VCOML instead of VCOMH where it is so described in the above description, and Vx is set to a voltage corresponding to black display, instead of white display in the same manner. Further, the data determination circuit 25 detects Vx based on a bit which is included in display data supplied from the data latch section 15 to the level shift section 14, and controls the switch 23 according to the bit data, POL and CS so as not to perform the equalization of the common line LCOM and the data line LDATA when Vx is set to a voltage corresponding to black display (when a data voltage applied to the data line LDATA is lower than a common voltage applied to the common line) in successive driving periods.

### Fourth Embodiment

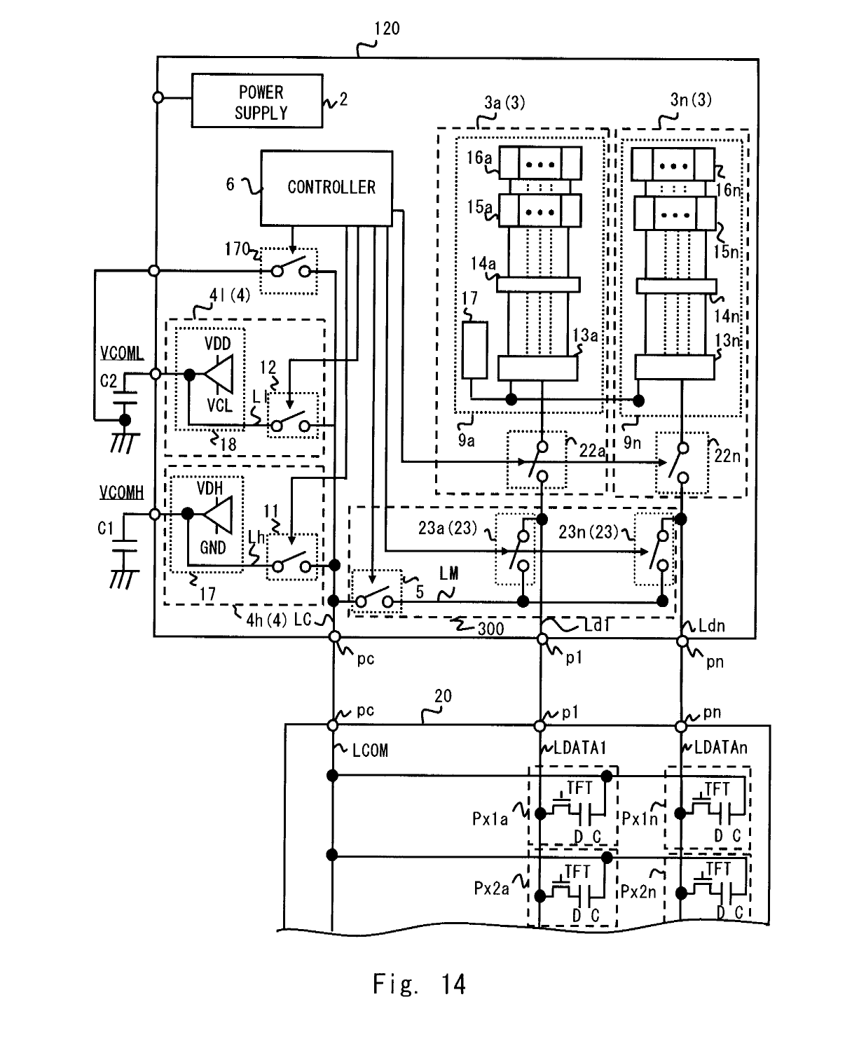

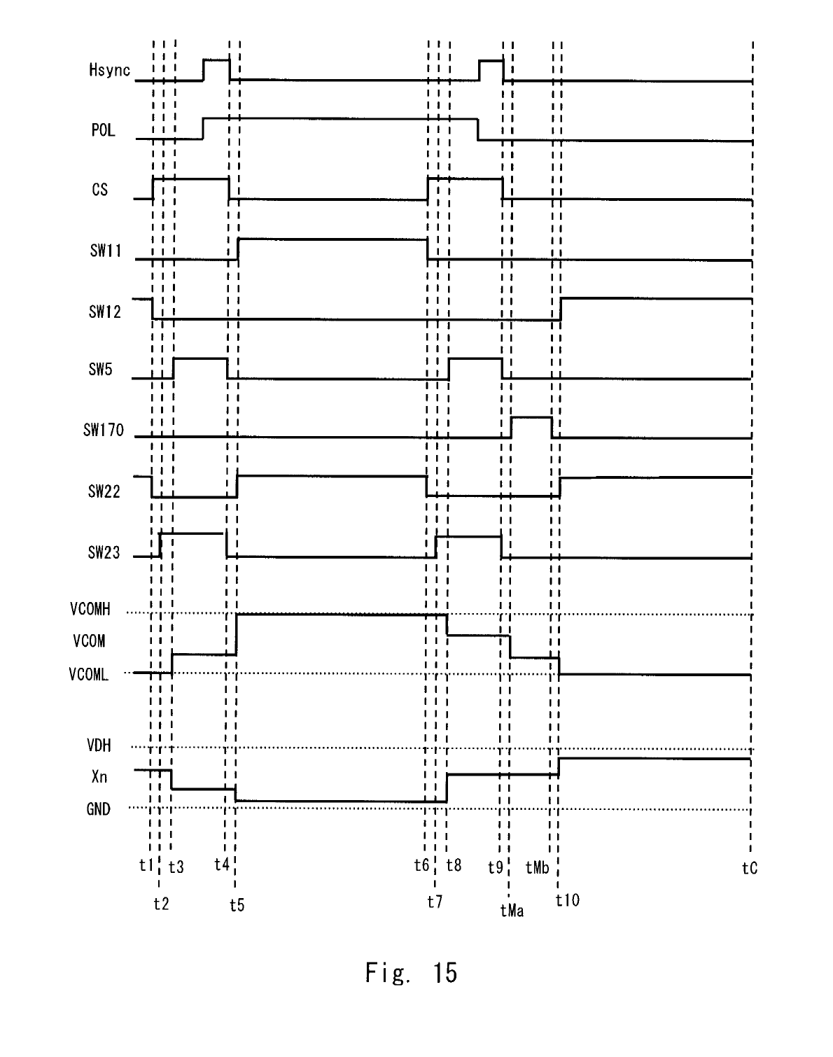

A fourth embodiment of the present invention is described hereinafter with reference to FIGS. 14 and 15. A redundant description is not provided herein.

The fourth embodiment is different from the first embodiment in that a driving circuit 120 includes a switch 170 (fourth switch) as shown in FIG. 14. One end of the switch 170 is connected with the line LC, and the other end is connected with one end of C2. The other end of C2 is grounded.

The switch 170 turns ON based on a control signal from the controller 6, and the line LC is thereby set to GND. The common line LCOM which is connected with the line LC is also set to GND. GND is a voltage between VCOMH and VCOML.

The operation of the driving circuit 120 is described hereinafter with reference to the timing chart of FIG. 15. The switch 170 (SW170) turns ON at tMa and turns OFF at tMb. The timings tMa and tMb occur within the period from t6 to t10. At tMa, the voltages of the common line LCOM and the data line LDATA are equalized as described earlier. When SW170 turns ON at tMa, COM is set to be a lower voltage, GND (0V). Then, SW170 turns OFF and SW12 and SW22 turn ON, thereby starting a driving period of a liquid crystal panel 20. In this driving period, COM is set to VCOML. Because the common line LCOM and the data line LDATA are equalized and further the level of COM is set to GND based on the operation of the switch 170 beforehand, the power consumption of the driving circuit 120, particularly the common line driver 4, can be reduced. GND is a voltage between VCOML and VCOMH, which is a voltage between different common voltages that are applied to the common line LCOM.

### Fifth Embodiment

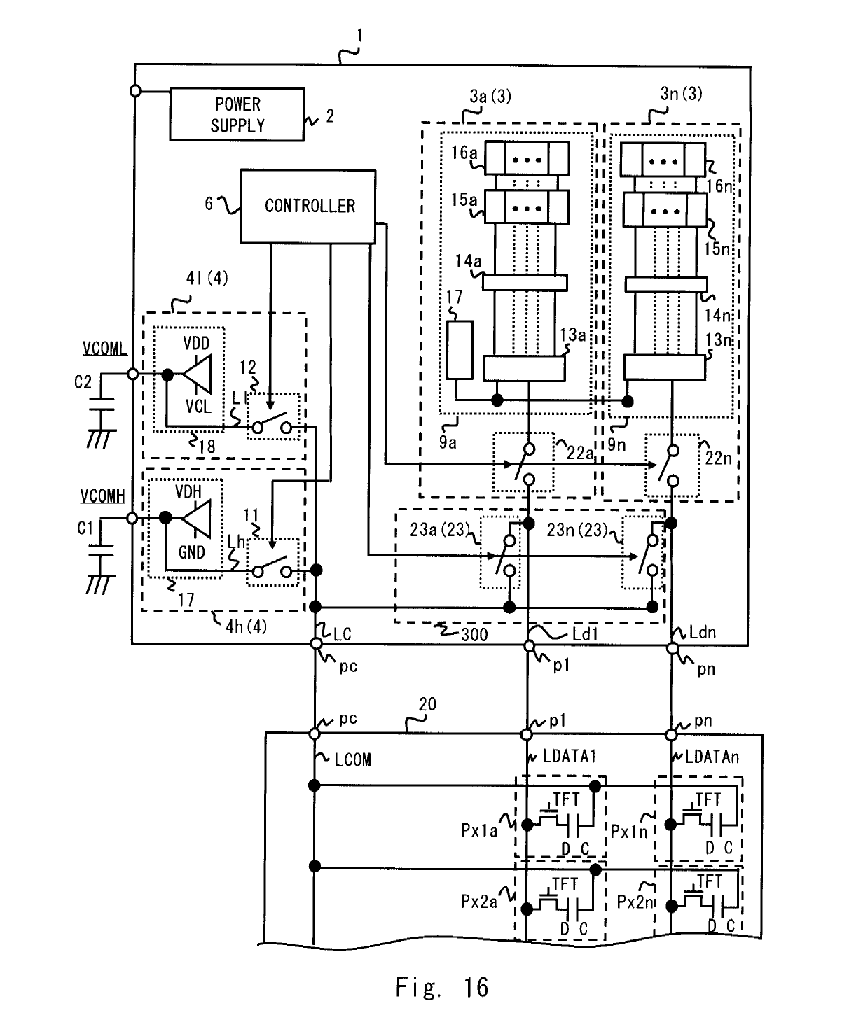

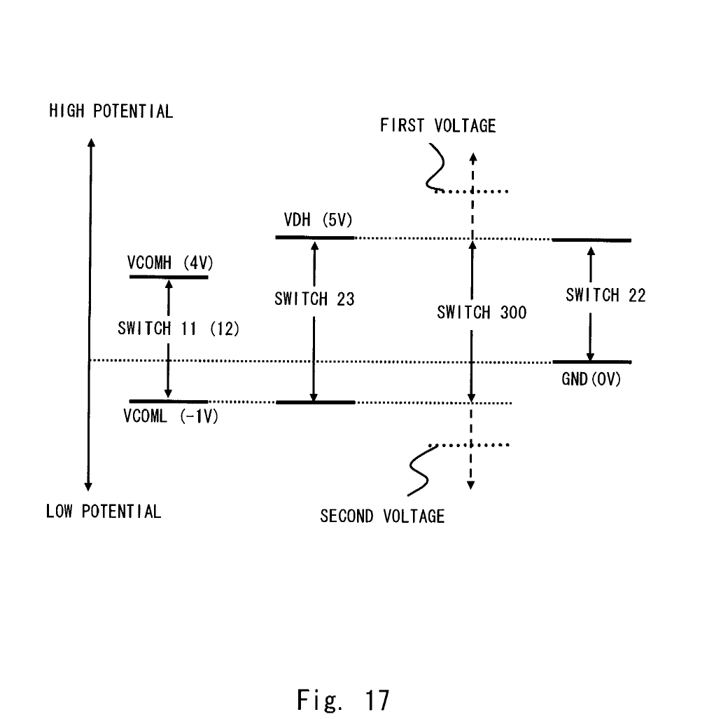

A fifth embodiment of the present invention is described hereinafter with reference to FIGS. 16 and 17. A redundant description is not provided herein.

The fifth embodiment is different from the first embodiment in that the switch section 300 is composed of the switch 23 (first switch) only as shown in FIG. 16 and that the operating voltage range of the switch 23 is VDH (5V) to VCOML (−1V), which is wider than in the first embodiment, as shown in FIG. 17. In this embodiment, the range of the operating voltage of the switch section 300 is regulated by the switch 23.

In such a configuration, the switch section 300 ensures insulation between the common line and the data line even when different operating voltage ranges are set to the common line driver 4 and the data line driver 3. This eliminates the need for enlarging the range of the operating voltage of the data line driver.

The present invention is not restricted to the above-described embodiments. A control signal which is supplied from the controller to each switch may be converted into a control signal with an appropriate voltage by a level shirt circuit, which is not shown. Each switch does not necessarily have the configuration illustrated in the cross-sectional views described above. The first conductivity type and the second conductivity type may be opposite.

It is apparent that the present invention is not limited to the above embodiment and it may be modified and changed without departing from the scope and spirit of the invention.

What is claimed is:

1. A driving circuit for a display apparatus comprising:
a common line driver to supply at least two different common voltages to a common line included in the display apparatus;
a plurality of data line drivers to supply a data voltage 5 to each of a plurality of data lines included in the display apparatus; and
a switch section having a larger operating voltage range than that of the data line drivers, to temporarily short-circuit the common line and the data line.

2. The driving circuit for the display apparatus according to claim 1, wherein
the operating voltage range of the switch section is defined by a first voltage being equal to or higher than a higher one selected from higher voltages of the common line driver and the data line drivers, and a second voltage being equal to or lower than a lower one selected from lower voltages of the common line driver and the data line drivers.

3. The driving circuit for the display apparatus according to claim 1, wherein the switch section comprises:
a first switch having one end connected with the data line and also connected with the data line driver; and
a second switch having one end connected with another end of the first switch and another end connected with the common line, wherein
a withstand voltage of an element forming the second switch is higher than a withstand voltage of an element forming the data line driver.

4. The driving circuit for the display apparatus according to claim 3, wherein
the operating voltage range of the second switch is defined by a first voltage being equal to or higher than a higher one selected from higher voltages of the common line driver and the data line drivers, and a second voltage being equal to or lower than a lower one selected from lower voltages of the common line driver and the data line drivers.

5. The driving circuit for the display apparatus according to claim 1, wherein the switch section comprises:
a first switch having one end connected with the data line and also connected with the data line driver and another end connected with the common line, wherein
a withstand voltage of an element forming the first switch is higher than a withstand voltage of an element forming the data line driver.

6. The driving circuit for the display apparatus according to claim 5, wherein
the operating voltage range of the first switch is defined by a first voltage being equal to or higher than a higher one selected from higher voltages of the common line driver and the data line drivers, and a second voltage being equal to or lower than a lower one selected from lower voltages of the common line driver and the data line drivers.

7. The driving circuit for the display apparatus according to claim 1, wherein the common line driver comprises:
a third switch to determine an output state of the common line driver, wherein
the third switch is composed of an element having substantially the same withstand voltage as that of the data line driver.

8. The driving circuit for the display apparatus according to claim 1, wherein the data line drivers respectively comprise:
a buffer to convert a digital signal into an analog signal, wherein
the buffer turns OFF based on a control signal.

9. The driving circuit for the display apparatus according to claim 5, wherein the data line drivers respectively comprise:
a data determination circuit to set the first switch to ON or OFF based on a digital signal corresponding to the data voltage.

10. The driving circuit for the display apparatus according to claim 1, further comprising:
a fourth switch placed in parallel with the common line driver and connected with the common line, wherein
the fourth switch sets a voltage of the common line to a level between an upper limit and a lower limit of a common voltage supplied from the common line driver to the common line based on a control signal.

11. A driving method of a driving circuit including a common line driver to supply at least two different common voltages to a common line included in a display apparatus, a plurality of data line drivers to supply a data voltage to each of a plurality of data lines included in the display apparatus, and a switch section having a larger operating voltage range than that of the data line drivers to temporarily short-circuit the common line and the data line, the method comprising:
supplying a common voltage from the common line driver to the common line when the switch section is OFF.

12. The driving method of the driving circuit according to claim 11, wherein
equalization between a voltage of the common line and a voltage of the data line are not performed if a data voltage supplied to the data line is higher than an upper limit of the common voltage supplied to the common line or lower than a lower limit of the common voltage supplied to the common line.

13. The driving method of the driving circuit according to claim 11, wherein
the data line is set to high impedance state when the common voltage supplied to the common line changes from a lower common voltage to a higher common voltage.
